(19) United States
(12) Patent Application Publication
(10) Pub. No.: US 2007/0163182 A1
(43) Pub. Date: Jul. 19, 2007

(54) Weather strip attachment clip

(76) Inventor: Yasuhiro Morihara, Hiroshima (JP)

Correspondence Address: FLYNN THIEL BOUTELL & TANIS, P.C., 2026 RAMBLING ROAD, KALAMAZOO, MI, 49008-1631, US

(21) Appl. No.: 11/600,420

(22) Filed: Nov. 16, 2006

(30) Foreign Application Priority Data
Jan. 13, 2006 (JP) 2006-006457

(51) Int. Cl. E06B 7/16

(52) U.S. Cl. 49/492.1; 49/475.1

(57) ABSTRACT

A clip comprises a panel engagement that is forcibly fitted in and engaged with a mounting hole formed in a door panel, a head that is larger in size than the inside diameter of a hole drilled in the weather strip and having a tapered section, a neck having the same tapered section as the hole, and a through-hole formed in the panel engagement and neck, wherein the neck passed through the hole has the same section as the hole so that the hole is not enlarged when the clip is attached, therefore preventing the weather strip from bulging due to the enlarged hole.

### CROSS-REFERENCE TO THE RELATED ART

This application incorporates by reference the subject matter of Application No. 2006-6457, filed in Japan on Jan. 13, 2006, on which a priority claim is based under 35 U.S.C. §119 (a).

### BACKGROUND OF THE INVENTION

1. Field of the Invention

The present invention relates to a weather strip attachment clip, for example a clip that is used for attaching a weather strip to the door opening edge of a body or the rim of a door panel of a vehicle.

2. Description of the Related Art

FIG. 4 shows a weather strip 1 that is attached to the rim of a rear door 14 of a four-door vehicle shown in FIG. 5. For the attachment to the door panel of the rear door 14, the weather strip 1 is drilled to form a hole 4 as shown in FIG. 7 at a position corresponding to a mounting hole 3 formed in a door panel 2 as shown in FIG. 6. Then, a clip 5 is pushed into the hole 4 from the head 5a in order for the head 5a to be caught by and engaged with the edge of the hole 4 as shown in FIG. 8. The clip 5 has a panel engagement 5b that is pushed in and engaged with the mounting hole 3 of the panel 2 attaching the weather strip 1 to the panel 2. In the figure, the number 6 indicates the door panel of the front door 15.

When the weather strip is drilled, a drill 7 is pressed against and pushed into the weather strip 1, deforming the weather strip 1 as shown in FIG. 9. As a result, a clip attaching hole 8 formed that has different diameters between the outside and inside of the weather strip 1. The inside diameter tends to be smaller than the outside diameter as shown in FIG. 10. When the head 5a of the clip 5 is pushed into such a hole 8 and the neck 5c is passed through it, the hole 8 is enlarged by the neck 5c, causing the weather strip 1 around the clip to bulge. Consequently, the weather strip 1 undulates as shown in FIG. 11, impairing the appearance of the vehicle. In the figure, the bulged parts result from the attachment of the clips 5.

One resolution to the above problem is to use a larger drill to form a larger hole 8. In such a case, the outside diameter becomes larger than the clip, creating a gap between them. Therefore, the weather strip can be easily shifted. When the weather strip is shifted, a part of the inner wall of the hole that is pressed against the clip receives intensive stress, which may cause the hole break, in which case the weather strip will tend to shift from the attached position.

Another resolution is to drill at a reduced speed. When the weather strip is drilled at reduced speed so that it receives less pressure, the difference between the inside and outside diameters can be reduced. However, this causes the problem of lowering working efficiency.

The purpose of the present invention is to provide a clip that eliminates the above mentioned undulation of the weather strip without increasing the hole size or reducing the drilling speed.

### SUMMARY OF THE INVENTION

The present invention relates to a clip for attaching a weather strip to the body or a door panel of a vehicle (simply termed the panel and the like hereafter). The clip comprises a panel engagement that is forcibly fitted into and engaged with a mounting hole formed in the panel and the like, a head that is pushed into a hole drilled in the weather strip and having a tapered section and is engaged with the edge of the hole, and a neck that connects the panel engagement and head and that is passed through the hole. The neck has a section tapered toward the head like the hole, and preferably has the same tapered section as the hole.

In the present invention, it is sufficient that the neck of the clip has a tapered longitudinal section in the direction perpendicular to the longitudinal direction of the weather strip and does not necessarily have a tapered transverse section in the longitudinal direction of the weather strip. Therefore, the tapered neck section in the context of the present invention has at least a tapered longitudinal section in the direction perpendicular to the longitudinal direction of the weather strip.

The present invention will become more fully understood from the detailed description given in below and the accompanying drawings are given by way of illustration only, and thus, are not limitative of the present invention, and wherein:

### BRIEF DESCRIPTION OF THE DRAWINGS

FIG. 1 is a plane view of the clip.

FIG. 2 is a cross-sectional view of a weather strip to which the clip shown in FIG. 1 is attached.

FIG. 3 is a partially cross-sectional view of a weather strip to which the clips are attached at proper intervals.

FIG. 4 is a schematic view of a weather strip attached to the rim of a rear door.

FIG. 5 is a side view of a four-door vehicle.

FIG. 6 is a cross-sectional view of a part of a door panel in which a mounting hole is formed.

FIG. 7 is a cross-sectional view of a weather strip.

FIG. 8 is a cross-sectional view of a weather strip at the Line 8-8 in FIG. 4 when it is attached to a door panel using a prior art clip.

FIG. 9 is a cross-sectional view of a weather strip while being drilled.

FIG. 10 is a cross-sectional view of a drilled hole.

FIG. 11 is an illustration showing the undulation of a weather strip caused by the clips.

### DESCRIPTION OF THE PREFERRED EMBODIMENT

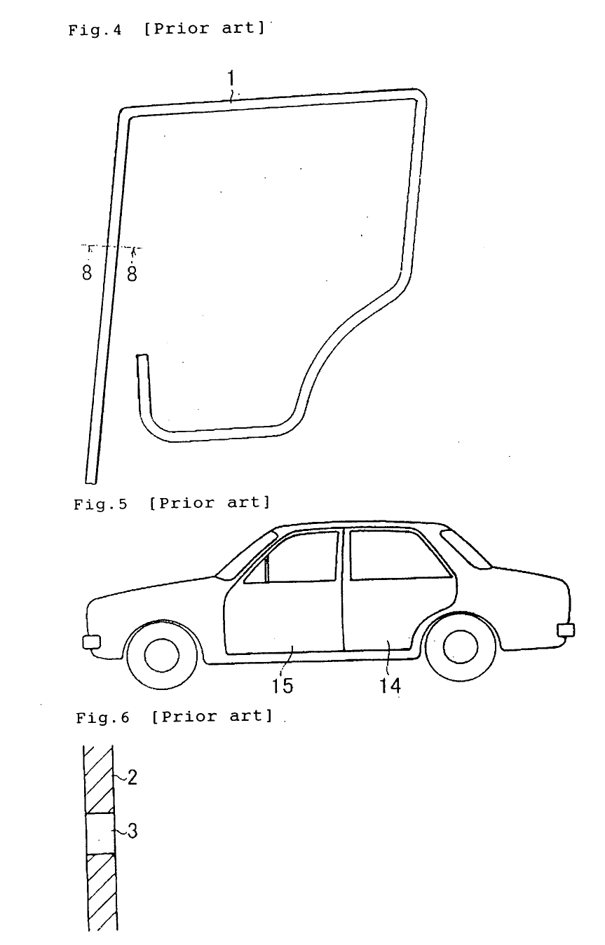

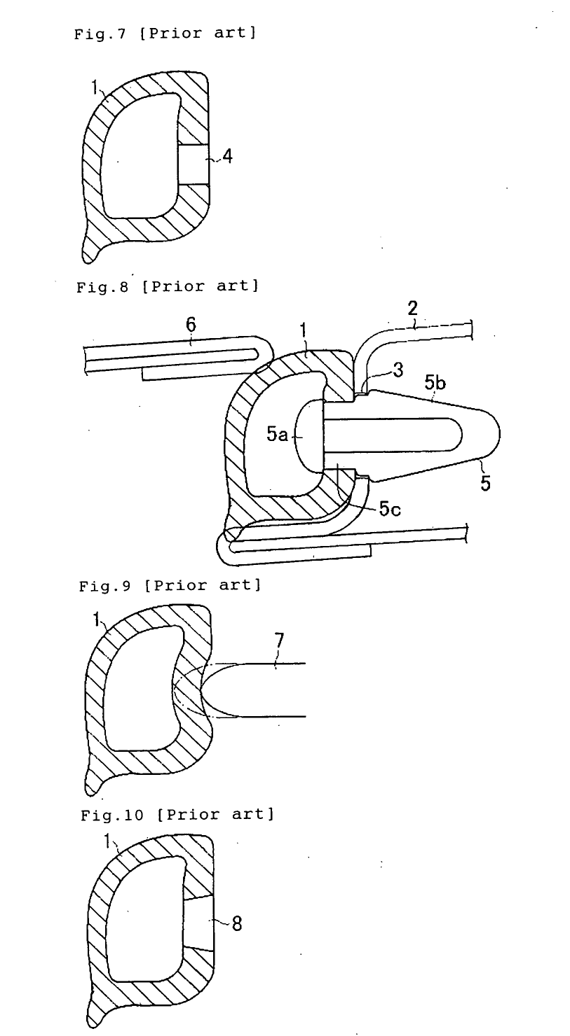

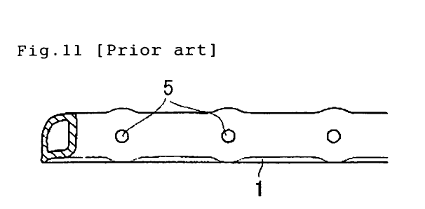

A clip according to an embodiment of the present invention for attaching a weather strip to a door panel is described hereafter, with reference to the drawings. In the figures, the same reference numbers are used to indicate the same components as those in FIGS. 4 to 11.

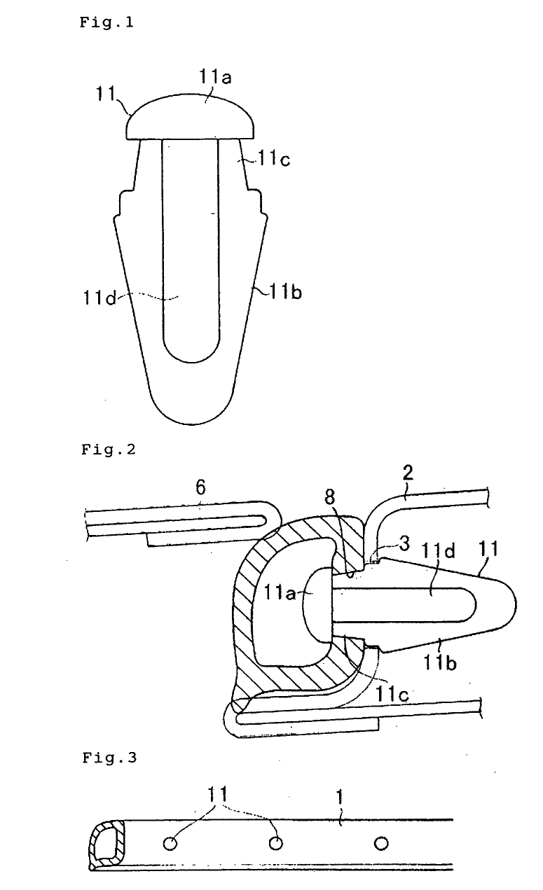

A clip 11 shown in FIG. 1 comprises a panel engagement 11b that is forcibly fit into and engaged with, for example, the mounting hole 3 formed in the door panel 2 shown in FIG. 6, a head 11a that is larger in size than the inside diameter of the hole 8 shown in FIG. 10 that is drilled into the weather strip and has a section tapered toward the inside, a neck 11c that connects the panel engagement 11b and head 11a and has a tapered longitudinal section, preferably the same tapered section as that of the hole 8, in the direction perpendicular to the longitudinal direction of the weather strip and a round transverse section in the direction parallel to the longitudinal direction of the weather strip, and a through-hole lid formed in the panel engagement 11b and neck 11c in the direction perpendicular to the drawing sheet. The clip 1 is integrally molded from hard resin, for example polypropylene. FIG. 2 shows the weather strip 1 attached to the rear door panel 2 using the clip 11. The neck 11c of the clip 11 is passed through the hole 8 formed in the weather strip 1 and the head 11a is engaged with the edge of the hole 8.

With the clip 11 of this embodiment, the neck 11c of the clip 11 passed through the hole 8 does not enlarge the hole 8 causing the weather strip 1 around the clip to bulge because the neck 11c and hole 8 has the same section. FIG. 3 shows the weather strip 1 to which the clips 11 are attached. As shown in the figure, the weather strip around the clips 11 is not bulged.

What is claimed is:

1. A clip for attaching a weather strip to the body or a door panel of a vehicle, comprising a panel engagement that is forcibly fit into and engaged with a mounting hole formed in the body or a door panel of a vehicle, a head that is pushed into a hole drilled in the weather strip and having a tapered section and is engaged with the edge of said hole, and a neck that connects said panel engagement and head and is passed through said hole, characterized in that said neck has a section tapered toward said head similar to said hole.
